(19) United States
(12) Patent Application Publication
(10) Pub. No.: US 2026/0179841 A1
(43) Pub. Date: Jun. 25, 2026

(54) MULTILAYER CERAMIC ELECTRONIC DEVICE

(71) Applicant: TAIYO YUDEN CO., LTD., Tokyo (JP)

(72) Inventor: Yuji TSUSHIMA, Tokyo (JP)

(73) Assignee: TAIYO YUDEN CO., LTD., Tokyo (JP)

(21) Appl. No.: 19/421,365

(22) Filed: Dec. 16, 2025

(30) Foreign Application Priority Data
Dec. 19, 2024 (JP) 2024-224163

(51) Int. Cl. H01G 4/12; H01G 4/012; H01G 4/30

(52) U.S. Cl. CPC H01G 4/1227; H01G 4/012; H01G 4/30

(57) ABSTRACT

A multilayer ceramic electronic device includes a multilayer body in which each of a plurality of dielectric layers and each of a plurality of internal electrode layers are alternately stacked. The plurality of dielectric layers have a main phase of first crystal grains of barium titanate having a perovskite structure represented by a general formula ABO₃. At least one of the plurality of internal electrode layers has a discontinuity, and a second crystal grain having an elemental ratio of barium to titanium of 0.70 or less is placed in the discontinuity.

### CROSS-REFERENCE TO RELATED APPLICATION

This application is based upon and claims the benefit of priority of the prior Japanese Patent Application No. 2024-224163, filed on Dec. 19, 2024, the entire contents of which are incorporated herein by reference.

### FIELD

A certain aspect of the present disclosure relates to a multilayer ceramic electronic device.

### BACKGROUND

Multilayer ceramic electronic devices such as multi-layer ceramic capacitors (MLCCs) are used in high-frequency communication systems, such as mobile phones.

### SUMMARY OF THE INVENTION

According to an aspect of the embodiments, there is provided a multilayer ceramic electronic device including: a multilayer body in which each of a plurality of dielectric layers and each of a plurality of internal electrode layers are alternately stacked, wherein the plurality of dielectric layers have a main phase of first crystal grains of barium titanate having a perovskite structure represented by a general formula ABO₃, and wherein at least one of the plurality of internal electrode layers has a discontinuity, and a second crystal grain having an elemental ratio of barium to titanium of 0.70 or less is placed in the discontinuity.

### BRIEF DESCRIPTION OF THE DRAWINGS

FIG. 1 is a partial cross-sectional perspective view of a multilayer ceramic capacitor;

FIG. 2 is a cross-sectional view taken along line A-A in FIG. 1;

FIG. 3 is a cross-sectional view taken along line B-B in FIG. 1;

FIG. 4A and FIG. 4B are enlarged cross-sectional views of vicinity of external electrodes;

FIG. 5 illustrates a schematic cross sectional view of a dielectric layer;

FIG. 6 is a diagram illustrating an example of a unit cell of a crystal grain having a perovskite structure;

FIG. 7 is a schematic cross-sectional view of a dielectric layer and an internal electrode layer;

FIG. 8 is a diagram illustrating an example of a 20 μm×20 μm region located in a center of a cross section of a multilayer ceramic capacitor polished in a B-B direction in FIG. 1;

FIG. 9 illustrates a flow of a manufacturing method of a multilayer ceramic capacitor;

FIG. 10A and FIG. 10B illustrate a formation process of internal electrode; and

FIG. 11 illustrates a crimping process.

### DETAILED DESCRIPTION

Multilayer ceramic capacitors (MLCCs) include a multilayer body of dielectric layers made of a dielectric ceramic composition with electrical capacitance, cover layers that sandwich the multilayer body from above and below, and side margins that sandwich the multilayer body from the sides. Because the amount of diffusion from the internal electrode layers in the multilayer body is small in the cover layer and side margins, the densification temperature is higher than in the dielectric layers, resulting in insufficient densification and problems with moisture resistance. One method for promoting densification of the cover layer and side margins is to add silicon (Si) or manganese (Mn) to the cover layer and side margins (Japanese Patent Application Publication No. 2011-124429 and Japanese Patent Application Publication No. 2017-011172). However, this results in the diffusion of manganese and silicon into the active section, causing a decrease in the relative dielectric constant and abnormal grain growth, resulting in reduced reliability.

Hereinafter, an exemplary embodiment will be described with reference to the accompanying drawings.

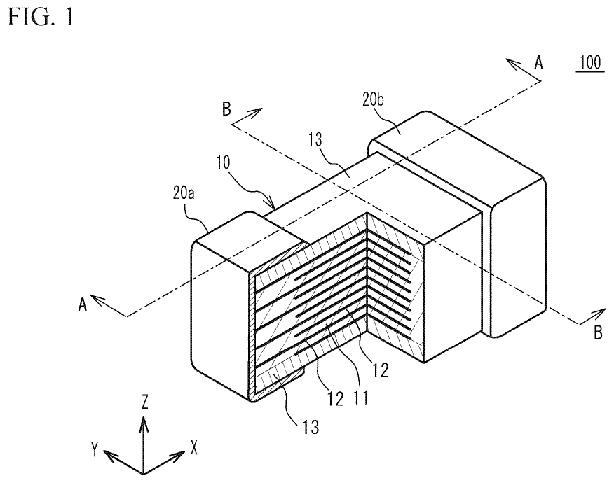

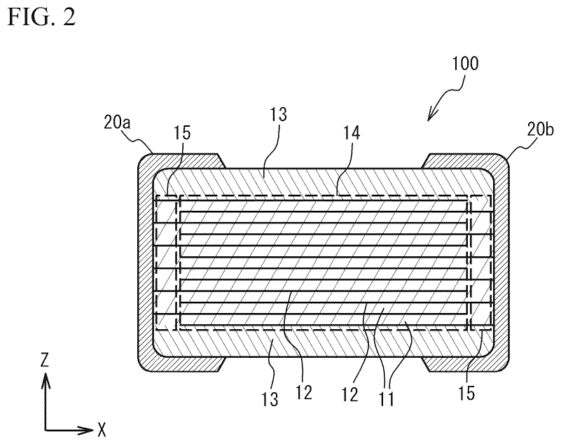

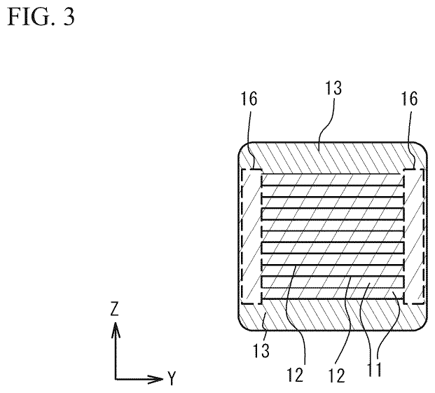

(Embodiment) FIG. 1 illustrates a perspective view of a multilayer ceramic capacitor 100, in which a cross section of a part of the multilayer ceramic capacitor 100 is illustrated. FIG. 2 is a cross-sectional view taken along line A-A in FIG. 1. FIG. 3 is a cross-sectional view taken along line B-B in FIG. 1. As illustrated in FIG. 1 to FIG. 3, the multilayer ceramic capacitor 100 includes an element body 10 having a rectangular parallelepiped shape, and external electrodes 20a and 20b that are respectively provided on two end faces of the element body 10 facing each other. Among four faces other than the two end faces of the element body 10, two faces other than the upper face and the lower face in the stacking direction are referred to as side faces. Each of the external electrodes 20a and 20b extends to the upper face and the lower face in the stacking direction and the two side faces of the element body 10. However, the external electrodes 20a and 20b are spaced from each other.

In FIG. 1 to FIG. 3, a Z-axis direction (first direction) is the stacking direction. The Z-axis direction is a direction in which internal electrode layers face each other. An X-axis direction (second direction) is a longitudinal direction of the element body 10. The X-axis direction is a direction in which the two end faces of the element body 10 are opposite to each other and in which the external electrode 20a is opposite to the external electrode 20b. A Y-axis direction (third direction) is a width direction of the internal electrode layers. The Y-axis direction is a direction in which the two side faces of the element body 10 are opposite to each other. The X-axis direction, the Y-axis direction and the Z-axis direction are orthogonal to each other.

The element body 10 has a structure designed to have dielectric layers 11 (dielectric ceramic composition) and internal electrode layers 12 alternately stacked. The dielectric layer 11 contains a ceramic material acting as a dielectric material. End edges of the internal electrode layers 12 are alternately exposed to a first end face of the element body 10 and a second end face of the element body 10 that is different from the first end face. The external electrode 20a is provided on the first end face. The external electrode 20b is provided on the second end face. Thus, the internal electrode layers 12 are alternately electrically connected to the external electrode 20a and the external electrode 20b. Accordingly, the multilayer ceramic capacitor 100 has a structure in which a plurality of the dielectric layers 11 are stacked with the internal electrode layers 12 interposed therebetween. In the multilayer body of the dielectric layers 11 and the internal electrode layers 12, the outermost layers in the stack direction are the internal electrode layers 12, and cover layers 13 cover the top face and the bottom face of the multilayer body. The cover layer 13 is mainly composed of a ceramic material. For example, the main component of the cover layer 13 may be the same as the main component of the dielectric layer 11 or may be different from the main component of the dielectric layer 11. Note that the configuration is not limited to those illustrated in FIG. 1 to FIG. 3, as long as the internal electrode layers 12 are exposed on two different surfaces and are electrically connected to different external electrodes.

For example, the multilayer ceramic capacitor 100 may have a length of 0.25 mm, a width of 0.125 mm, and a height of 0.125 mm. The multilayer ceramic capacitor 100 may have a length of 0.4 mm, a width of 0.2 mm, and a height of 0.2 mm. The multilayer ceramic capacitor 100 may have a length of 0.6 mm, a width of 0.3 mm, and a height of 0.3 mm. The multilayer ceramic capacitor 100 may have a length of 1.0 mm, a width of 0.5 mm, and a height of 0.5 mm. The multilayer ceramic capacitor 100 may have a length of 3.2 mm, a width of 1.6 mm, and a height of 1.6 mm. The multilayer ceramic capacitor 100 may have a length of 4.5 mm, a width of 3.2 mm, and a height of 2.5 mm. However, the size of the multilayer ceramic capacitor 100 is not limited to the above sizes.

The main component of the internal electrode layer 12 is not particularly limited, but is a base metal such as Ni (nickel), Cu (copper), Sn (tin). As a main component of the internal electrode layers 12, noble metals such as Pt (platinum), Pd (palladium), Ag (silver), Au (gold), and alloys containing these may be used. The internal electrode layer 12 may include a ceramic grain such as a co-material. The thickness of the internal electrode layers 12 is, for example, 0.1 μm or more and 3.0 μm or less, 0.1 μm or more and 2.0 μm or less, or 0.1 μm or more and 1.0 μm or less. The thickness of the internal electrode layers 12 can be measured by observing a cross section of the multilayer ceramic capacitor 100 with a scanning electron microscope (SEM), measuring the thickness at 10 points for each of 10 different internal electrode layers 12, and deriving the average value of all the measurement points.

A main component of the dielectric layer 11 is a ceramic material having a perovskite structure expressed by a general formula ABO₃. The perovskite structure includes ABO_{3-α} having an off-stoichiometric composition. In the embodiment, the ceramic material is BaTiO₃ (barium titanate). For example, the dielectric layers 11 contain 90 at % or more of barium titanate. The thickness of the dielectric layers 11 is, for example, 0.1 μm or more and 10.0 μm or less, 0.1 μm or more and 5.0 μm or less, or 0.1 μm or more and 2.0 μm or less. The thickness of the dielectric layers 11 can be measured by observing a cross section of the multilayer ceramic capacitor 100 with a scanning electron microscope (SEM), measuring the thickness at 10 points for each of the 10 different dielectric layers 11, and deriving the average value of all the measurement points.

Additives may be added to the dielectric layer 11. As additives to the dielectric layer 11, zirconium (Zr), hafnium (Hf), magnesium (Mg), manganese (Mn), molybdenum (Mo), vanadium (V), chromium (Cr), rare earth elements (yttrium (Y), samarium (Sm), europium (Eu), gadolinium (Gd), terbium (Tb), dysprosium (Dy), holmium (Ho), erbium (Er), thulium (Tm), and ytterbium (Yb)) or an oxide of cobalt (Co), nickel (Ni), lithium (Li), boron (B), sodium (Na), potassium (K) or silicon (Si), or a glass including cobalt, nickel, lithium, boron, sodium, potassium or silicon.

As illustrated in FIG. 2, the section where the internal electrode layers 12 connected to the external electrode 20a faces the internal electrode layers 12 connected to the external electrode 20b is a section where capacity is generated in the multilayer ceramic capacitor 100. Thus, this section is referred to as a capacity section 14. That is, the capacity section 14 is a section where two adjacent internal electrode layers 12 connected to different external electrodes face each other.

The section where the internal electrode layers 12 connected to the external electrode 20a face each other with no internal electrode layer 12 connected to the external electrode 20b interposed therebetween is referred to as an end margin 15. The section where the internal electrode layers 12 connected to the external electrode 20b face each other with no internal electrode layer 12 connected to the external electrode 20a interposed therebetween is also the end margin 15. That is, the end margin 15 is a section where the internal electrode layers 12 connected to one of the external electrodes face each other with no internal electrode layer 12 connected to the other of the external electrodes interposed therebetween. The end margin 15 is a section where no capacity is generated.

As illustrated in FIG. 3, in the element body 10, a side margin 16 is a section provided so as to cover the ends (ends in the Y-axis direction) of the two side faces of the dielectric layers 11 and the internal electrode layers 12. That is, the side margin 16 is a section provided outside the capacity section 14 in the Y-axis direction. The side margin 16 is also a section where no capacity is generated.

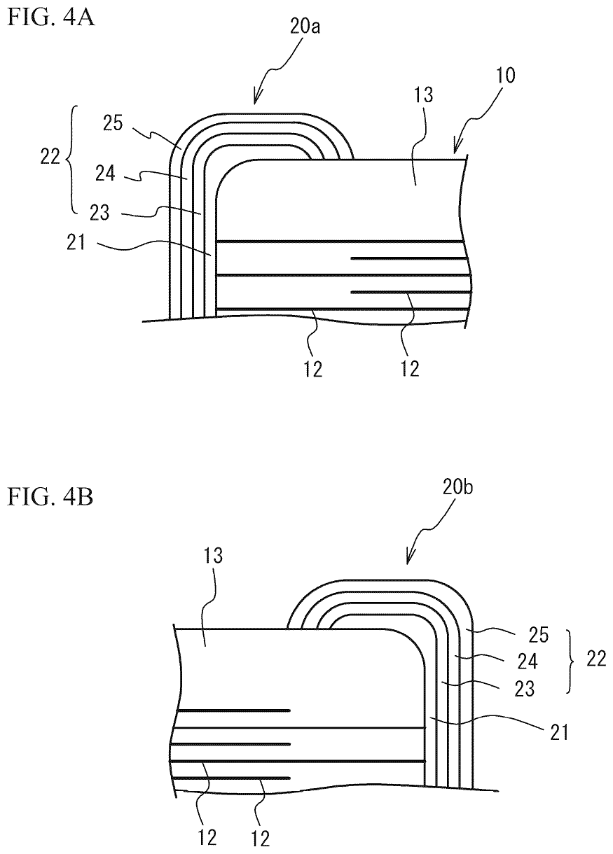

FIG. 4A is an enlarged cross-sectional view of the vicinity of the external electrode 20a. FIG. 4B is an enlarged cross-sectional view of the vicinity of the external electrode 20b. In FIG. 4A and FIG. 4B, hatches are omitted. As illustrated in FIG. 4A and FIG. 4B, the external electrodes 20a and 20b have a structure in which a plated layer 22 is provided on a base layer 21. The base layer 21 is primarily composed of nickel, copper, or the like. The base layer 21 may contain a ceramic grain or a glass component as a co-material. The plated layer 22 is primarily composed of a metal such as nickel, copper, aluminum, zinc, or tin, or an alloy of two or more of these metals. The plated layer 22 may be a plated layer of a single metal component or multiple plated layers of different metal components. For example, the plated layer 22 has a structure in which a first plated layer 23, a second plated layer 24, and a third plated layer 25 are formed in this order from the base layer 21 side. The first plated layer 23 is, for example, a copper plated layer. The second plated layer 24 is, for example, a nickel plated layer. The third plated layer 25 is, for example, a tin plated layer.

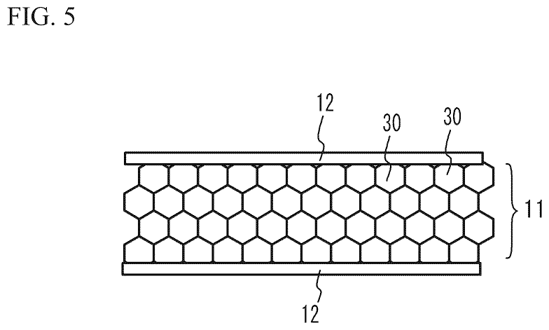

FIG. 5 is a schematic cross-sectional view of the dielectric layer 11. As illustrated in FIG. 5, the dielectric layer 11 has a structure in which a plurality of first crystal grains 30 constituting the main phase are sintered. For example, the number of the first crystal grains 30 in the dielectric layer 11 may be one in the thickness direction thereof. Alternatively, the dielectric layer 11 may have a structure in which the plurality of first crystal grains 30 are connected via grain boundaries, as illustrated in FIG. 5. The first crystal grain 30 may be barium titanate, or may be barium titanate in which another element is solid-dissolved.

The multilayer ceramic capacitor 100 according to this embodiment has a configuration that can suppress reliability degradation while maintaining the moisture resistance of the cover layer 13 and the side margins 16. Details are described below.

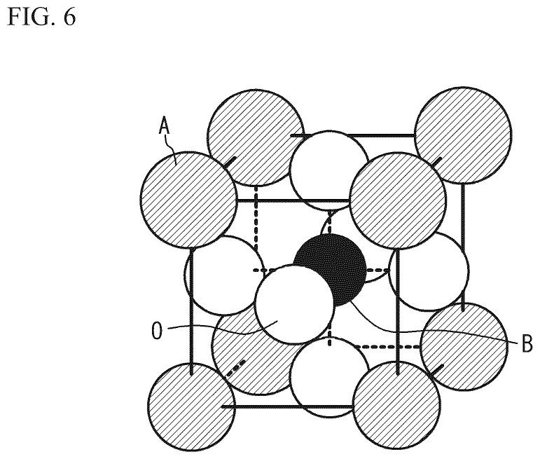

The first crystal grain 30 illustrated in FIG. 5 is a crystal grain of barium titanate (BaTiO₃) with a perovskite structure. Crystal grains with a perovskite structure have a unit lattice such as that illustrated in FIG. 6. This unit cell contains A sites located at the lattice vertices, O sites located at the lattice face centers, and B sites located within an octahedron with the O sites as vertices. In a perovskite structure, alkaline earth metals capable of taking divalent cations, such as barium (Ba), strontium (Sr), and calcium (Ca), occupy the A site, while metal atoms capable of taking tetravalent cations, such as hafnium (Hf), zirconium (Zr), and titanium (Ti), occupy the B site. In this embodiment, barium occupies the A site, titanium occupies the B site, and at least one of the A and B sites may be substituted with an additional element.

The perovskite structure also allows for compositional formulas that deviate from the stoichiometric composition. That is, the ratio of A-site elements to B-site elements does not necessarily need to be 1:1; defects may be present within the range that allows the perovskite structure to be maintained. Oxygen defects may also be present. For example, when the composition formula is A_{α}BO_{3-β}, a composition within the ranges of 0.98≤α≤1.01 and 0≤β≤0.20 is acceptable.

However, for example, the formation of oxygen vacancies can reduce resistivity or exhibit ionic conductivity, which can shorten the electrical life of multilayer ceramic capacitors and increase dielectric loss, making them unusable for practical use. For this reason, the first crystal grains 30 having a perovskite structure may optionally contain at least one of the first transition elements: scandium (Sc), titanium (Ti), vanadium (V), chromium (Cr), iron (Fe), cobalt (Co), nickel (Ni), copper (Cu), or zinc (Zn). This can improve resistivity, extend electrical life, and reduce dielectric loss relative to electrostatic capacity.

Furthermore, the first crystal grains 30 may optionally contain at least one of the following second transition elements: yttrium (Y), zirconium (Zr), niobium (Nb), molybdenum (Mo), ruthenium (Ru), rhodium (Rh), palladium (Pd), or silver (Ag). This can improve resistivity, extend electrical life, and reduce dielectric loss relative to electrostatic capacity.

The first crystal grains 30 may also optionally contain at least one of the third transition elements: lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), lutetium (Lu), hafnium (Hf), tantalum (Ta), tungsten (W), rhenium (Re), osmium (Os), iridium (Ir), platinum (Pt), or gold (Au). This can improve resistivity, extend electrical life, and reduce dielectric loss relative to electrostatic capacity.

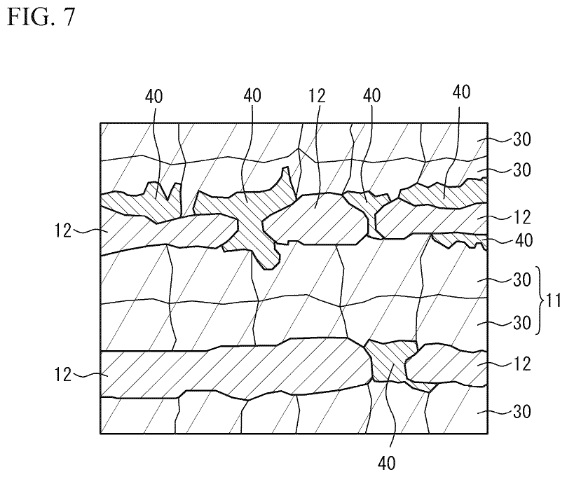

FIG. 7 is a schematic cross-sectional view of the dielectric layer 11 and the internal electrode layer 12. As illustrated in FIG. 7, in a cross section including the Z-axis direction (for example, an XZ cross section, a YZ cross section, or the like), a discontinuity occurs in at least a portion of the internal electrode layer 12. The discontinuity refers to a gap occurring between a partial region of the internal electrode layer 12 and another region of the internal electrode layer 12 in any direction of the XY plane. The second crystal grain 40 is arranged in the discontinuity of the internal electrode layer 12. Specifically, the second crystal grain 40 is arranged in the discontinuity of the internal electrode layer 12 so as to contact any of the first crystal grains 30 in one of the dielectric layers 11 via a grain boundary and to contact any of the first crystal grains 30 in an adjacent one of the dielectric layers 11 via a grain boundary. The second crystal grain 40 is preferably arranged across the entire width of the discontinuity so as to contact both the partial region of the internal electrode layer 12 and another region of the internal electrode layer 12.

If the discontinuity occurs in the internal electrode layers 12 and the discontinuity becomes a void, moisture may penetrate the void from the outside, potentially reducing moisture resistance. This reduced moisture resistance may lead to a deterioration in insulation. In contrast, in this embodiment, the insulating second crystal grain 40 is placed in the discontinuity of the internal electrode layers 12, thereby preventing moisture penetration and reducing insulation degradation. It is anticipated that the shortest distance between the discontinuities in the internal electrode layer 12 in the XY plane will be 0.1 μm or more and 20.0 μm or less.

If a configuration is adopted that reduces the reduction in moisture resistance in the capacity section 14, the amount of silicon, manganese, and other elements that promote densification added to the cover layer 13 and side margin 16 can be reduced, or even eliminated. Therefore, for example, the ceramic components of the dielectric layer 11 and the ceramic components of the cover layer 13 and side margin 16 can have the same composition.

The second crystal grain 40 is produced when barium titanate is combined with an additive (such as titanium oxide) whose primary component is titanium. They are barium titanate-based composite oxides with a barium to titanium element ratio (ratio of the number of elements) of 0.70 or less. Examples of the second crystal grain 40 is such as BaTi₂O₅, BaTi₄O₉, BaTi₅O₁₁, BaTi₆O₁₃, Ba₄Ti₁₁O₂₆, Ba₄Ti₁₂O₂₇, Ba₄Ti₁₃O₃₀, or Ba₆Ti₁₇O₄₀.

Among these, the second crystal grain 40 is preferably a barium titanate composite oxide, such as Ba₄Ti₁₁O₂₆, which is a monoclinic crystal system represented by the space group C2/m and has lattice constants a=15.160 Å, b=3.893 Å, c=9.093 Å, and β=98.6°. This is because the barium titanate composite oxide has a barium to titanium ratio relatively close to 1, making it easy to intentionally precipitate without using large amounts of additives whose main component is titanium. This barium titanate composite oxide is described, for example, in the non-patent literature Acta Cryst. (1979). B35, 1590-1593.

A more suitable example of the second crystal grain 40 is one in which manganese solid-dissolves in Ba₄Ti₁₁O₂₆, occupying the vacancy sites or substituting for some of the titanium. As is clear from the above-mentioned non-patent document, Ba₄Ti₁₁O₂₆ has a crystal structure in which vacancies occur at some of the titanium sites. This makes it easy for titanium to change from tetravalent cations to trivalent cations at the vacancy sites, resulting in a decrease in resistivity. To compensate for this, the presence of manganese in solid solution is effective.

The presence of the second crystal grain 40 in the discontinuity of the internal electrode layer 12 can be confirmed by the following procedure.

First, the diffraction line profile of the surface of the dielectric layer 11 to be confirmed, or of powder obtained by pulverizing the dielectric layer 11, is measured using an X-ray diffractometer (XRD) using Cu-Kα radiation. The grinding method for obtaining the powder is not particularly limited, and a hand mill (mortar and pestle) or the like can be used. Furthermore, when measuring the diffraction profile of the ceramics constituting the multilayer ceramic capacitor 100, the electrodes and coatings formed on the surface of the element, as well as portions other than the dielectric layer 11 of the multilayer ceramic capacitor 100, are removed to expose the surface of the dielectric layer 11. The method for this exposure is not particularly limited, and methods such as cutting or polishing the element can be used. Furthermore, when measuring the diffraction profile of powder of the dielectric layer 11 constituting the multilayer ceramic capacitor 100, it is more preferable to grind the material after removing the external electrodes 20a, 20b and coatings formed on the element, as well as portions other than the dielectric layer 11 of the multilayer ceramic capacitor 100.

Next, in the obtained diffraction profile, the percentage of the strongest diffraction ray intensity due to other structures relative to the strongest diffraction ray intensity due to the perovskite structure is calculated. If this percentage is 10% or less, the dielectric layer 11 being confirmed is determined to be composed of a main phase having a perovskite structure. It should be noted that when the surface of the dielectric layer 11 of the multilayer ceramic capacitor 100 is exposed by the above-mentioned method, or when XRD measurement is performed on pulverized powder, peaks of the external electrodes 20a, 20b, the internal electrode layer 12, and the material constituting the coating may also be detected, and these peaks are excluded before calculating the ratio of diffraction line intensities described above.

Next, the crystalline phase is identified by focusing on peaks other than diffraction intensity due to the perovskite structure. To identify the crystalline phase, it is desirable to search the PDF (Powder Diffraction File) published by the ICDD (International Centre for Diffraction Data; Pennsylvania, USA) to confirm whether crystal grains are present. In the case of Ba₄Ti₁₁O₂₆, a suitable example, its formation can be evaluated by identifying it with reference to PDF-01-083-1459.

Next, the following method is used to determine whether the crystal grains are made of a barium titanate-based composite oxide in which the elemental ratio of barium to titanium is 0.70 or less, and whether the second crystal grain is located in the discontinuity portion of the internal electrode layer.

First, the surface of the dielectric layer 11 is exposed. There are no particular restrictions on the method for this exposure, and methods such as cutting or polishing the element can be used. In this case, to fully observe the internal ceramic structure, it is preferable to finally use a diamond paste of 2 μm or less to achieve a smoothness that can be considered a mirror surface.

Next, the composition and precipitation locations of the second crystal grain 40 is identified using an energy dispersive X-ray spectrometry (EDS) or wavelength dispersive X-ray spectrometry (WDS) attached to a scanning electron microscope (SEM) or a transmission electron microscope (TEM), an electron probe microanalyzer (EPMA), or laser-induced coupled plasma mass spectrometry (LA-ICP-MS).

For example, in EDS measurements, each element is identified simply by titanium K-ray intensity relative to the K-ray or L-ray of barium and the K-ray of manganese. More specifically, these intensities are corrected (ZAF correction) to account for atomic number effects, absorption effects, and fluorescence excitation effects, and the ratio of each to the titanium element content is calculated, which is then used as the ratio of each element.

When performing EDS measurements, particularly with barium Lα and titanium Kα rays, the energy peaks are close to each other, making it difficult to accurately compare elemental contents. For this reason, it is desirable to obtain sufficient intensity of barium Lβ2 and LIIIab rays without peak overlap. Specifically, it is desirable for the peak intensity to be 10,000 counts or more. In this case, the intensity of the characteristic X-rays of barium can be identified and the elemental content can be calculated. Therefore, even if the barium Lα and Ti Kα rays overlap, the intensity of the titanium Kα rays can be identified, allowing for accurate evaluation of the elemental content.

When the elemental ratio of barium to titanium obtained by the above method is 0.70 or less, the crystal grain is determined to be the second crystal grain 40. In other words, a crystal grain is determined to be one of the above barium titanate composite oxides because its elemental ratio of barium to titanium is lower than that of the surrounding barium titanate. When using an SEM for observation, crystal grains are characterized by being relatively low in brightness and appearing darker than barium titanate in backscattered electron images (BSE images). A more suitable method of identification is to identify the crystal grains by evaluating the diffraction profile using XRD. Next, more specifically, the portions identified as crystal grains are cut out as samples for observation with a transmission electron microscope (TEM). The diffraction image obtained using selected area diffraction is compared with data from known literature to confirm whether the grains can be identified as BaTi₂O₅, BaTi₄O₉, BaTi₅O₁₁, BaTi₆O₁₃, Ba₄Ti₁₁O₂₆, Ba₄Ti₁₂O₂₇, Ba₄Ti₁₃O₃₀, or Ba₆Ti₁₇O₄₀. This cutting can be performed using an FIB device or similar.

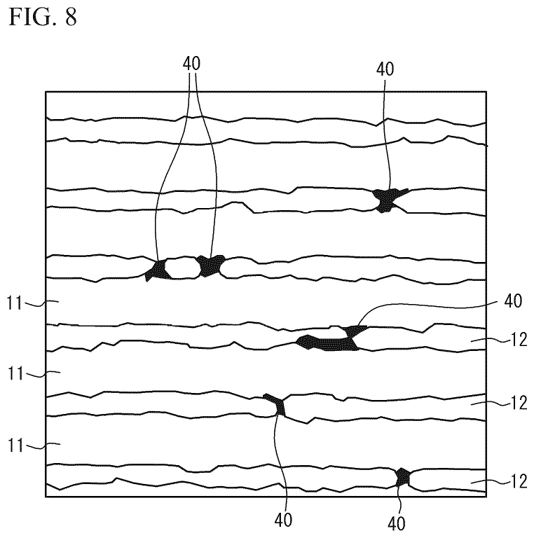

Next, the area ratio of the second crystal grain will be described. While there is no particular need to set a lower limit for the area ratio of the second crystal grains 40 in the cross section, if the area ratio of the second crystal grains 40 is too large, many second crystal grains 40 may be present inside the dielectric layer 11. In this case, the relative dielectric constant of the dielectric layer 11 may be reduced. Therefore, it is preferable to set an upper limit for the area ratio of the second crystal grains 40 in the cross section. In this embodiment, the area ratio of the second crystal grains in a 20 μm×20 μm region located in the center of a cross section of the multilayer ceramic capacitor 100 polished in the B-B direction in FIG. 1 is preferably 50% or less, more preferably 10% or less, and even more preferably 5.0% or less. The area ratio of the second crystal grains 40 in the cross section can be measured, for example, by identifying the second crystal grains using SEM-EDS, measuring the total area of the second crystal grains from the SEM image, and dividing by the field area. FIG. 8 illustrates an example of a 20 μm×20 μm region located in the center of a cross section of the multilayer ceramic capacitor 100 polished in the B-B direction of FIG. 1.

From a similar perspective, if the elemental ratio of barium to titanium in the cross section is too high, many second crystal grains 40 may be present inside the dielectric layer 11. In this case, the relative dielectric constant of the dielectric layer 11 may be reduced. Therefore, it is preferable to set an upper limit on the elemental ratio of barium to titanium in the cross section. In this embodiment, in the cross section including the discontinuity portion of the internal electrode layer 12 and the dielectric layer 11, the elemental ratio of barium to titanium is preferably 0.995 or less, more preferably 0.990 or less, and even more preferably 0.980 or less. The elemental ratio of barium to titanium can be measured by SEM-EDS analysis, as described above.

On the other hand, if the area ratio of the second crystal grains 40 in the cross section is too small, there is a risk that the number of discontinuities where the second crystal grain 40 is not located will increase, for example, when there are many discontinuities in the internal electrode layer 12. Therefore, it is preferable to set a lower limit for the area ratio of the second crystal grains 40 in the cross section. In this embodiment, the area ratio occupied by the second crystal grains in a 20 μm×20 μm region located in the center of a cross section of the multilayer ceramic capacitor 100 polished in the B-B direction in FIG. 1 is preferably 0.001% or more, more preferably 0.1% or more, and even more preferably 10% or more.

From a similar perspective, if the elemental ratio of barium to titanium in the cross section is too low, there is a risk that the number of discontinuities in the internal electrode layer 12 where the second crystal grain 40 is not arranged will increase, for example, when there are many discontinuities in the internal electrode layer 12. Therefore, it is preferable to set a lower limit for the elemental ratio of barium to titanium in the cross section. In this embodiment, in the cross section including the discontinuities in the internal electrode layer 12 and the dielectric layer 11, the elemental ratio of barium to titanium is preferably 0.909 or more, more preferably 0.926 or more, and even more preferably 0.962 or more.

Note that, in the above-mentioned 20 μm×20 μm region, there may be, for example, one to 20 discontinuities in the internal electrode layer 12, and the second crystal grain 40 may be arranged in 5.0% to 90% of these discontinuities.

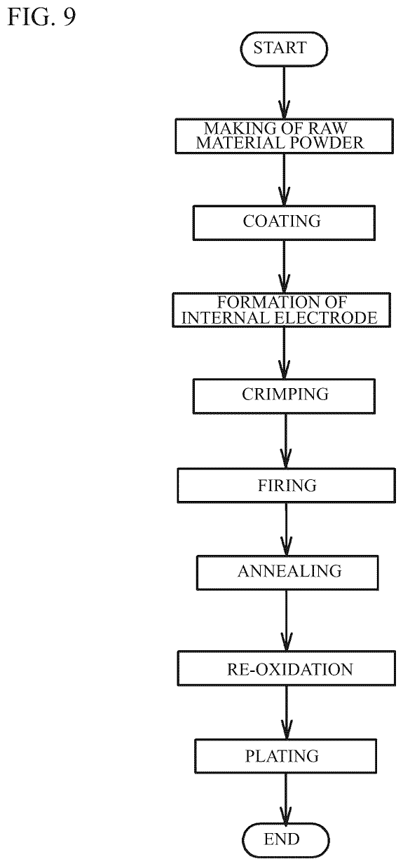

Next, a description will be given of a manufacturing method of the multilayer ceramic capacitors 100. FIG. 9 illustrates a manufacturing method of the multilayer ceramic capacitor 100.

(Making process of raw material powder) First, a dielectric ceramic composition for forming the dielectric layer 11 is prepared. The A-site elements and B-site elements contained in the dielectric layer 11 are usually contained in the dielectric layer 11 in the form of a sintered body of ABO₃ grains. For example, barium titanate is a compound that has a perovskite structure and belongs to the tetragonal system at around room temperature, and exhibits a high relative dielectric constant. Generally, barium titanate is obtained by reacting a titanium material such as titanium dioxide with a barium material such as barium carbonate and synthesizing barium titanate. Various methods have been known for synthesizing barium titanate powder, such as the solid phase method, the sol-gel method, the hydrothermal method, etc. Any of these methods can be used in this embodiment.

Titanium is added to the obtained barium titanate powder. For example, titanium oxide (TiO₂) can be added. In this embodiment, it is preferable to add titanium to the barium titanate powder so that the elemental ratio of barium to titanium is 0.900 or more and 0.995 or less. For example, 0.5 mol or more and 10 mol or less of titanium is added to 100 mol of barium titanate powder.

Predetermined additives are added to the obtained ceramic powder. As an example, oxides or glasses containing Zr (zirconium), V (vanadium), Cr (chromium), Co (cobalt), Ni (nickel), Li (lithium), B (boron), Na (sodium), or K (potassium) may be used. Furthermore, oxides of Gd (gadolinium), Sc (scandium), Y (yttrium), La (lanthanum), Ce (cerium), Pr (praseodymium), Nd (neodymium), Pm (promethium), Sm (samarium), Tb (terbium), Dy (dysprosium), Ho (holmium), Er (erbium), Tm (thulium), Y (ytterbium), or Lu (lutetium) may be added as rare earth elements, if necessary.

For example, a ceramic material is prepared by wet-mixing a ceramic raw material powder with a compound containing an additive compound, followed by drying and pulverization. For example, the ceramic material obtained as described above may be pulverized as needed to adjust the particle size, or may be combined with a classification process to adjust the particle size. A dielectric material is obtained through the above process.

(Coating process) Next, a binder such as polyvinyl butyral (PVB) resin, an organic solvent such as ethanol or toluene, and a plasticizer are added to the obtained dielectric material and wet-mixed. Using the obtained slurry, a ceramic green sheet 51 is formed on the substrate by, for example, a die coater method or a doctor blade method, and dried. The substrate is, for example, polyethylene terephthalate (PET) film. Illustrating of the coating process is omitted.

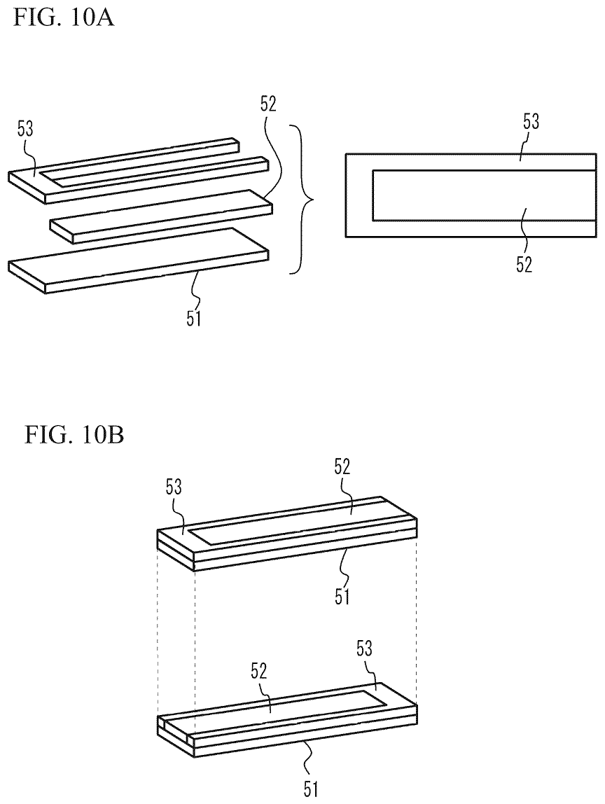

(Forming process of internal electrode) Next, as illustrated in FIG. 10A, a metal conductive paste for forming internal electrodes containing an organic binder is printed on the surface of the ceramic green sheet 51 by screen printing, gravure printing, or the like to form internal electrodes. Thus, an internal electrode pattern 52 for layers is arranged. Ceramic particles may be added to the metal conductive paste as a co-material. The main component of the ceramic particles is not limited. However, it is preferable that the main component of the ceramic particles is the same as the main component of the dielectric layer 11. For example, barium titanate having an average particle size of 50 nm or less may be uniformly dispersed.

Next, a binder such as ethyl cellulose and an organic solvent such as terpineol are added to the dielectric ceramic composition obtained in the making process of the raw material powder, and the mixture is kneaded in a roll mill to form a dielectric pattern paste for the reverse pattern layer. As illustrated in FIG. 10A, a dielectric pattern 53 is formed by printing the resulting slurry in the peripheral region, where the internal electrode pattern 52 is not printed, on the ceramic green sheet 51 to cause the dielectric pattern 53 and the internal electrode pattern 52 to form a flat surface. The ceramic green sheet 51 on which the internal electrode pattern 52 and the dielectric pattern 53 are printed is referred to as a stack unit.

Thereafter, as illustrated in FIG. 10B, a predetermined number of stack units are stacked so that the internal electrode layers 12 and the dielectric layers 11 are alternated with each other and the end edges of the internal electrode layers 12 are alternately exposed to both end faces in the length direction of the dielectric layer 11 so as to be alternately led out to a pair of the external electrodes 20a and 20b of different polarizations. In this embodiment, the number of the internal electrode pattern 52 is 100 to 1000.

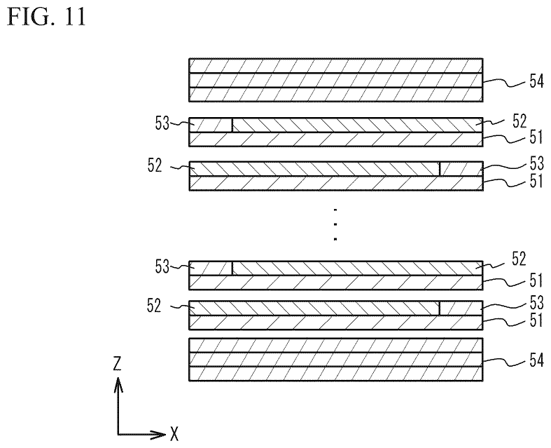

(Crimping process) As illustrated in FIG. 11, a predetermined number (for example, 2 to 10) of cover sheets 54 are stacked on top and bottom of a multilayer body in which the stack units are stacked, and then thermocompression bonded. The multilayer body is then cut to a predetermined chip size (for example, 1.0 mm×0.5 mm).

(Firing Process) The ceramic multilayer body thus obtained is subjected to binder removal processing in an N₂ atmosphere, air atmosphere, or the like, followed by dipping with a metal paste that will form the base layer of the external electrodes 20a and 20b. The ceramic multilayer body is then fired at 1100° C. to 1300° C. for 10 minutes to 2 hours in a reducing atmosphere with an oxygen partial pressure of 10⁻¹² to 10⁻⁹ atm, followed by rapid cooling. In this manner, the multilayer ceramic capacitor 100 is obtained. The temperature rise rate during the firing process is rapid, for example, at 6000° C./h. This shortens the actual firing time and enables greater mass productivity.

(Annealing Process) Then, the ceramic multilayer body is annealed in a reducing atmosphere with an oxygen partial pressure of 10⁻¹² to 10⁻⁹ atm at 1000 to 1150° C. for 1-2 hours and then slowly cooled. For example, the temperature is increased and decreased at a rate of 400° C./h.

(Re-oxidation process) Thereafter, a re-oxidation process may be performed in an N₂ gas atmosphere at 600 to 1000° C.

(Plating process) After that, metal layers such as copper, nickel, and tin may be formed on the external electrodes 20a and 20b by plating. Thus, the multilayer ceramic capacitor 100 is manufactured.

The manufacturing method according to this embodiment allows barium titanate to be sintered during the firing process. Because titanium is added to the barium titanate, the constituent components that can form the second crystal grain 40 appears as a liquid phase during the annealing process that follows the firing process, and are expelled from the dielectric layer 11. In the internal electrode layer 12, discontinuities occur where the metal components are spheroidized during the firing process. The liquid phase expelled from the dielectric layer 11 moves to the discontinuities in the internal electrode layer 12, and becomes the second crystal grain 40 after cooling. As described above, the second crystal grain 40 can be arranged in the discontinuities in the internal electrode layer 12.

Note that in each of the above embodiments, a multilayer ceramic capacitor has been described as an example of a multilayer ceramic electronic device, but the present invention is not limited thereto. For example, other multilayer ceramic electronic devices such as varistors and thermistors may be used.

### EXAMPLES

(Example 1) 4.0 mol of titanium was added to 100 mol of barium titanate powder, resulting in a ceramic powder Ba/Ti elemental ratio (the elemental ratio of barium to titanium) of 0.960. This ceramic powder was mixed with ethanol, toluene, and PVB (polyvinyl butyral) resin to prepare a dielectric slurry. This slurry was formed into ceramic green sheets using a die coater. After drying, these ceramic green sheets were printed with nickel paste to form internal electrode patterns. The resulting stack units were stacked, and thick layers of ceramic green sheets without internal electrode patterns were pressed together on top and bottom, and then cut into small pieces. Ni paste was then dipped into the two end faces as a conductive paste for the external electrodes, and the pieces were de-bindered in nitrogen gas. The de-bindered pieces were fired at 1220° C. for 1 minute at an oxygen partial pressure of 9.6×10⁻⁹ atm and a heating rate of 6000° C./h, followed by rapid cooling. The samples were then annealed at 1100° C. for two hours in a reducing atmosphere with an oxygen partial pressure of 6.0×10⁻⁹ atm, followed by slow cooling. The annealing temperature increase rate was 400° C./h, and the temperature decrease rate was 400° C./h. The samples were then re-oxidized at 950° C. with an oxygen partial pressure of 1.0×10⁻² atm.

(Comparative Example 1) In Comparative Example 1, the annealing process was not performed. All other conditions were the same as in Example 1.

(Presence or Absence of Second Crystal Grain) For each sample in Example 1 and Comparative Example 1, we checked whether second crystal grains with a barium to titanium element ratio of 0.70 or less were present in the discontinuity portions of the internal electrode layers. The results are shown in Table 1. In Example 1, the second crystal grain (Ba₄Ti₁₁O₂₆) was confirmed to be present in the discontinuity portions of the internal electrode layers. This is believed to be due to the annealing process. In contrast, in Comparative Example 1, it was confirmed that the second crystal grain was not located in the discontinuities of the internal electrode layers. This is believed to be due to the absence of the annealing process.

TABLE 1

| | Ti AMOUNT | | |
|---|---|---|---|
| | WITH RESPECT TO | | |
| | 100 mol BaTiO₃ | | |
| | (mol) | ANNEALING | HUMIITY |
| COMPARATIVE | 4 | NOT | X |
| EXAMPLE 1 | | PERFORMED | |
| EXAMPLE 1 | 4 | PERFORMED | ◯ |

(Moisture Resistance Test) Each sample of Example 1 and Comparative Example 1 was maintained at 40° C. and 90% relative humidity for 500 hours, then left at room temperature for 24 hours. The insulation resistance was then evaluated. An insulation resistance value of 10 MΩ or greater was judged as acceptable “∘”, and an insulation resistance value of less than 10 MΩ was judged as unacceptable “x”. The results are shown in Table 1. As shown in Table 1, Example 1 was judged as acceptable “∘” in the moisture resistance test. This is believed to be due to the presence of insulating second crystal grain located in the discontinuities of the internal electrode layers. In contrast, Comparative Example 1 was judged as unacceptable “x”. This is believed to be due to the absence of the second crystal grain located in the discontinuities of the internal electrode layers.

(Comparative Example 2) 0.2 mol of titanium was added to 100 mol of barium titanate, resulting in a Ba/Ti elemental ratio of 1.000 in the ceramic powder. Other conditions were the same as in Example 1.

(Example 2) 0.5 mol of titanium was added to 100 mol of barium titanate, resulting in a Ba/Ti elemental ratio of 0.995 in the ceramic powder. Other conditions were the same as in Example 1.

(Example 3) 1.0 mol of titanium was added to 100 mol of barium titanate, resulting in a Ba/Ti elemental ratio of 0.990 in the ceramic powder. Other conditions were the same as in Example 1.

(Example 4) 2.0 mol of titanium was added to 100 mol of barium titanate, resulting in a Ba/Ti elemental ratio of 0.980 in the ceramic powder. Other conditions were the same as in Example 1.

(Example 5) 4.0 mol of titanium was added to 100 mol of barium titanate, resulting in a Ba/Ti elemental ratio of 0.970 in the ceramic powder. Other conditions were the same as in Example 1.

(Example 6) 8.0 mol of titanium was added to 100 mol of barium titanate, resulting in a Ba/Ti elemental ratio of 0.920 in the ceramic powder. Other conditions were the same as in Example 1.

(Example 7) 10 mol of titanium was added to 100 mol of barium titanate, resulting in a Ba/Ti elemental ratio of 0.909 in the ceramic powder. Other conditions were the same as in Example 1.

(Presence or Absence of Second Crystal Grain) For each sample in Examples 2 to 7 and Comparative Example 2, we checked whether second crystal grains with a barium-to-titanium elemental ratio of 0.70 or less were present in the discontinuities of the internal electrode layers. Table 2 shows the results. In Examples 2 to 7, the second crystal grain (Ba₄Ti₁₁O₂₆) were confirmed to be present in the discontinuities of the internal electrode layers. This is believed to be due to the sufficient amount of titanium added per 100 mol of barium titanate and the annealing process being performed. In Comparative Example 2, this is believed to be due to the Ba/Ti ratio of 1.000, which resulted in an insufficient amount of titanium added.

TABLE 2

| | Ti AMOUNT | | | | |
|---|---|---|---|---|---|
| | WITH RESPECT | | | | |
| | TO | | SECOND | | RELATIVE |
| | 100 mol BaTiO₃ | Ba/Ti | CRYSTAL | | DIELECTRIC |
| | (mol) | RATIO | GRAIN | HUMIDITY | CONSTANT |
| COMPARATIVE | 0.02 | 1.000 | ABSENT | X | 3500 |
| EXAMPLE 2 | | | | | |
| EXAMPLE 2 | 0.5 | 0.995 | PRESENT | ◯ | 3430 |
| EXAMPLE 3 | 1 | 0.990 | PRESENT | ◯ | 3380 |
| EXAMPLE 4 | 2 | 0.980 | PRESENT | ◯ | 3300 |
| EXAMPLE 5 | 4 | 0.962 | PRESENT | ◯ | 3210 |
| EXAMPLE 6 | 8 | 0.926 | PRESENT | ◯ | 2850 |
| EXAMPLE 7 | 10 | 0.909 | PRESENT | ◯ | 2400 |

(Moisture Resistance Test) Each sample in Examples 2 to 7 and Comparative Example 2 was stored at 40° C. and 90% relative humidity for 500 hours, then left at room temperature for 24 hours. The insulation resistance was then evaluated. An insulation resistance value of 10 MΩ or greater was judged as acceptable “∘”, while an insulation resistance value of less than 10 MΩ was judged as unacceptable “x”. The results are shown in Table 2. As shown in Table 2, Examples 2 to 7 were judged as acceptable “∘” in the moisture resistance test. This is believed to be because the second crystal grain was placed in the discontinuities of the internal electrode layer. In contrast, Comparative Example 2 was judged as unacceptable “x” in the moisture resistance test. This is believed to be because the second crystal grain was not placed in the discontinuities of the internal electrode layer.

(Dielectric Constant Test) Electrostatic capacity was measured using an LCR meter at a temperature of 25° C., a measurement voltage of 1.0 V, and a measurement frequency of 1 kHz. The relative dielectric constant was calculated from the dielectric thickness and electrode area. The results are shown in Table 2. As shown in Table 2, it was confirmed that the relative dielectric constant tended to decrease as the Ba/Ti ratio decreased. This is thought to be because, as the Ba/Ti ratio decreases, more second crystal grains having a barium to titanium elemental ratio of 0.70 or less are generated inside the dielectric layer. From these results, it can be seen that the Ba/Ti ratio is preferably 0.909 or more and 0.995 or less.

Although the embodiments of the present invention have been described in detail, it is to be understood that the various changes, substitutions, and alterations could be made hereto without departing from the spirit and scope of the invention.

What is claimed is:

1. A multilayer ceramic electronic device comprising:
a multilayer body in which each of a plurality of dielectric layers and each of a plurality of internal electrode layers are alternately stacked,
wherein the plurality of dielectric layers have a main phase of first crystal grains of barium titanate having a perovskite structure represented by a general formula ABO₃, and
wherein at least one of the plurality of internal electrode layers has a discontinuity, and a second crystal grain having an elemental ratio of barium to titanium of 0.70 or less is placed in the discontinuity.

2. The multilayer ceramic electronic device as claimed in claim 1,
wherein the second crystal grain is at least one selected from BaTi₂O₅, BaTi₄O₉, BaTi₅O₁₁, BaTi₆O₁₃, Ba₄Ti₁₁O₂₆, Ba₄Ti₁₂O₂₇, Ba₄Ti₁₃O₃₀, or Ba₆Ti₁₇O₄₀.

3. The multilayer ceramic electronic device as claimed in claim 1,
wherein, in a 20 μm×20 μm region located at a center of a cross section including a stacking direction of the plurality of dielectric layers and the plurality of internal electrode layers, an area ratio occupied by a total of each of the second crystal grain is 0.001% or more and 50% or less.

4. The multilayer ceramic electronic device as claimed in claim 1,
wherein, in the plurality of dielectric layers, an elemental ratio of barium to titanium is 0.909 or more and 0.995 or less.

5. The multilayer ceramic electronic device as claimed in claim 1,
wherein the second crystal grain is arranged across an entire width of the discontinuity.
